(19) United States
(12) Patent Application Publication
(10) Pub. No.: US 2023/0129738 A1
(43) Pub. Date: Apr. 27, 2023

(54) A-PILLAR AIRBAG SYSTEM

(71) Applicant: Electric Last Mile, Inc., Debtor, Wilmington, DE (US)

(72) Inventor: CHANG JU, Rochester, MN (US)

(73) Assignee: Electric Last Mile, Inc., Debtor, c/o David W. Carickhoff, Chapter 7 Trustee, Wilmington, DE (US)

(21) Appl. No.: 17/973,058

(22) Filed: Oct. 25, 2022

Related U.S. Application Data
(60) Provisional application No. 63/271,879, filed on Oct. 26, 2021.

(51) Int. Cl. B60R 21/213; B60R 21/232

(52) U.S. Cl. CPC B60R 21/213; B60R 21/232

(57) ABSTRACT

Systems and methods herein are directed to an interior trim system of a front pillar of a vehicle. The interior trim system can include a panel. The panel can include a user-facing surface and an interior surface located opposite the user-facing surface. The interior surface can define a volume of space to house a curtain air bag in an attached position. The panel can include a boss extending from the interior surface of the panel. The panel can include an aperture extending from the user-facing surface through the boss. The interior trim system can include a shoulder bolt. The shoulder bolt can have a head portion, a flange, a smooth portion, and a threaded portion. The panel can move relative to the shoulder bolt by a threshold distance in a deployed position such that the curtain air bag can deploy through an opening created by movement of the panel.

### CROSS REFERENCE TO RELATED APPLICATION

This application claims the benefit of U.S. Provisional Application No. 63/271,879 filed on Oct. 26, 2021.

### BACKGROUND

The present disclosure relates generally to an A-Pillar airbag system for a vehicle. More specifically, the present disclosure relates to an A-Pillar airbag system for properly deploying a side curtain airbag.

### SUMMARY

One embodiment relates to an interior trim system of a front pillar of a vehicle. The interior trim system can include a panel. The panel can include a user-facing surface and an interior surface. The interior surface is located opposite the user-facing surface. The interior surface can define a volume of space to house a portion of a curtain air bag in an attached position. The panel can include a boss extending from the interior surface of the panel. The panel can include an aperture extending from the user-facing surface through the boss. The interior trim system can include a shoulder bolt. The shoulder bolt can have a head portion, a flange, a smooth portion, and a threaded portion. The panel can move relative to the shoulder bolt by a predetermined threshold distance in a deployed position such that the curtain air bag can deploy through an opening created by movement of the panel.

One embodiment relates to a vehicle. The vehicle can include an exterior and an interior. The vehicle can include a front pillar disposed adjacent a portion of the interior of the vehicle. The vehicle can include an interior trim system of the front pillar. The interior trim system can include a panel. The panel can include a user-facing surface and an interior surface. The interior surface is located opposite the user-facing surface. The interior surface can define a volume of space to house a portion of a curtain air bag in an attached position. The panel can include a boss extending from the interior surface of the panel. The panel can include an aperture extending from the user-facing surface through the boss. The interior trim system can include a shoulder bolt. The shoulder bolt can have a head portion, a flange, a smooth portion, and a threaded portion. The panel can move relative to the shoulder bolt by a predetermined threshold distance in a deployed position such that the curtain air bag can deploy through an opening created by movement of the panel.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a perspective view of a panel of the vehicle of FIG. 1, according to an exemplary embodiment.

FIG. 3 is a perspective view of a portion of the panel of FIG. 2, according to an exemplary embodiment.

FIG. 4 is a side view of a portion of an interior trim system of the vehicle of FIG. 1, according to an exemplary embodiment.

FIG. 5 is a cross-sectional view of a portion of an interior trim system of the vehicle of FIG. 1 in an attached position, according to an exemplary embodiment.

FIG. 6 is a cross-sectional view of a portion of an interior trim system of the vehicle of FIG. 1 in a deployed position, according to an exemplary embodiment.

FIG. 7 is a cross-sectional overlay view of a portion of an interior trim system of the vehicle of FIG. 1 between an attached position and a deployed position, according to an exemplary embodiment.

FIG. 8 is a perspective view of a portion of an interior trim system of the vehicle of FIG. 1, according to an exemplary embodiment.

FIG. 9 depicts a portion of the vehicle of FIG. 1 in an attached position, according to an exemplary embodiment.

FIG. 10 depicts a portion of the vehicle of FIG. 1 in a deployed position, according to an exemplary embodiment.

FIG. 11 depicts a portion of the interior trim system in an attached position, according to an exemplary embodiment.

FIG. 12 depicts a portion of the interior trim system in a deployed position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle can include an exterior and an interior. The vehicle can include a front pillar disposed adjacent a portion of the interior of the vehicle. The vehicle can include an interior trim system of the front pillar. The interior trim system can include a panel. The panel can include a user-facing surface and an interior surface. The interior surface is located opposite the user-facing surface. The interior surface can define a volume of space to house a portion of a curtain air bag in an attached position. The panel can include a boss extending from the interior surface of the panel. The panel can include an aperture extending from the user-facing surface through the boss. The interior trim system can include a shoulder bolt. The shoulder bolt can have a head portion, a flange, a smooth portion, and a threaded portion. The panel can move relative to the shoulder bolt by a predetermined threshold distance in a deployed position such that the curtain air bag can deploy through an opening created by movement of the panel.

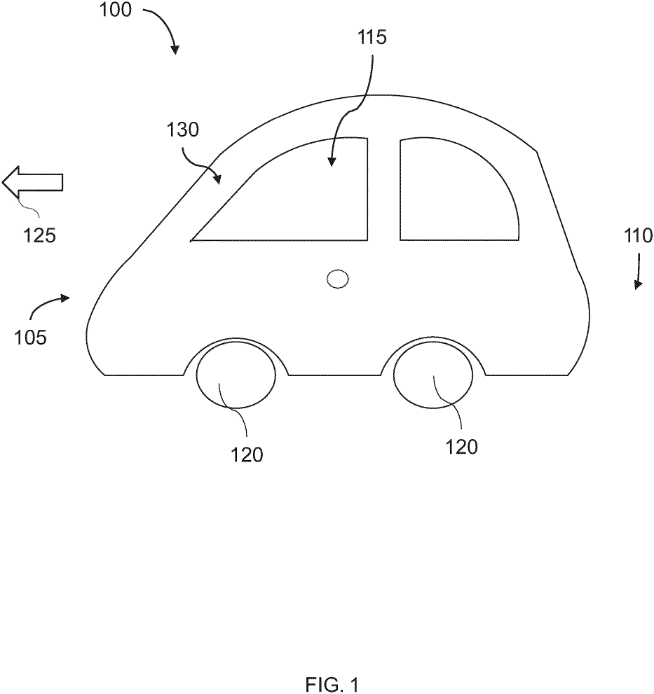

As shown in FIG. 1, a vehicle 100 can include a front end 105 and an opposing rear end 110. For example, the front end 105 can be positioned towards the front of the vehicle 100 such that, in a normal operating position, the front end 105 is at the front of a forward direction of travel, as shown in arrow 125. The vehicle 100 can include a cabin 115. For example, the cabin 115 can include space for an operator of the vehicle 100. Generally, the operating cabin 115 can be enclosed by a body, frame, or outermost portion of the vehicle 100. For example, the body of the vehicle 100 can include a frame and a plurality of wheels 120 coupled to the frame for movably supporting the vehicle 100 relative to a plane (e.g., road, ground, etc.). By way of example, the cabin 115 can include one or more seats for a user to operate the vehicle 100. According to another example, the vehicle 100 may be operated autonomously or semi-autonomously (e.g., vehicle includes a sensor for automatic steering, etc.). The vehicle 100 can include two front wheels 120 and two rear wheels 120, as shown in FIG. 1.

In one embodiment, the vehicle 100 is configured as an on-road vehicle such as a sedan, a sport utility vehicle (“SUV”), a pickup truck, a van, and/or still another type of passenger vehicle. In other embodiments, the vehicle 100 is configured as another type of on-road vehicle such as a semi-truck, a bus, or the like. In still other embodiments, the vehicle 100 is configured as an off-road vehicle such as construction machinery, farming machinery, or the like. The vehicle 100 can be any electric vehicle (e.g., EV, BEV, HEV, PHEV, etc.), an internal combustion engine vehicle, or another similar vehicle.

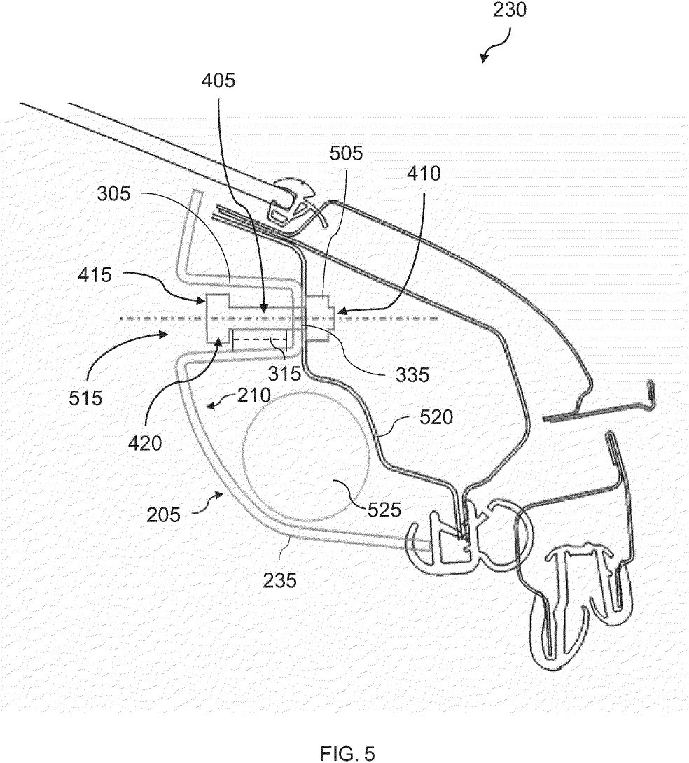

The vehicle 100 can include a plurality of supports. For example, the vehicle 100 may include one or more pillars, such as a front-end pillar 130. The front-end pillar 130, commonly known as an A-pillar, is generally a vertical or nearly vertical support disposed towards the front end 105 of the vehicle 100. Generally, one or more side curtain airbags (e.g., the airbag 525 shown in FIGS. 5-7) can be disposed adjacent an interior portion of the front-end pillar 130. Such curtain airbags can be configured to deploy upon impact, such as a side impact crash, to facilitate protecting an occupant within the cabin 115 from injury during the impact. For example, upon collision, an interior portion of the A-pillar may shift, reorient, or otherwise move slightly such that the airbag can deploy towards a portion of user of the vehicle 100 (e.g., within cabin 115), as described in greater detail below.

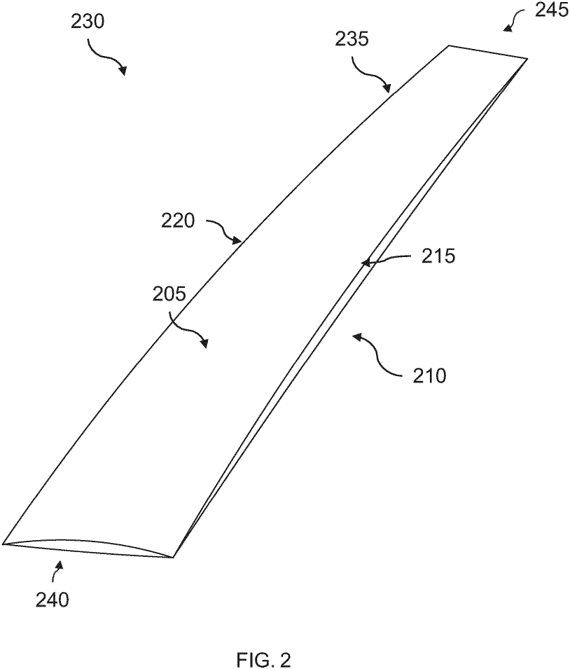

FIG. 2 depicts a perspective view of a portion of the front-end pillar 130. In particular, FIG. 2 depicts a portion of an interior trim system 230 of the front-end pillar 130. The interior trim system 230 may include a panel 235. The panel 235 may couple to or integrally form with an interior portion of the vehicle (e.g., adjacent the cabin 115, not exposed to an external environment, etc.). For example, the panel 235 may be a decorative piece, or trim, configured to be mounted adjacent, proximate, or otherwise near the front-end pillar 130 of the vehicle 100 adjacent the cabin 115. As shown in FIG. 2, the panel 235 can include a user-facing surface 205 and an interior surface 210. The interior surface 210 can be positioned opposite the user-facing surface 205. For example, the user-facing surface 205 may include one portion exposed to a user within an interior portion of the cabin 115 during normal operating conditions (e.g., while a user is operating the vehicle 100). The interior surface 210 may oppose the user-facing surface 205 such that at least a portion of the interior surface 210 is not exposed to a user of the vehicle 100 during normal operating conditions.

The panel 235 can include a top end 215 and a bottom end 220. For example, the top end 215 can be the end of the panel 235 that is closest to a highest point of the vehicle 100 in a normal operating condition (e.g., furthest point away from the wheels 120 while the wheels 120 are positioned on ground). The bottom end 220 can be an end of the panel 235 that is closest to a lowest point of the vehicle 100 in a normal operating condition (e.g., near the wheels 120). The panel 235 may include a first side 240 portion and a second side 245 portion. In various embodiments, the first side 240 portion at least partially opposes the second side 245 portion, as shown in FIG. 2, and among others. The panel 235 can have a generally curved, angled, or arcuate shape to conform to one or more interior portions of the vehicle 100. For example, the panel 235 may be slightly arcuate in shape such that the interior surface 210 creates a portion of a volume of space disposed between the panel 235 and another portion of the vehicle, such as the interior of the front-end pillar 130.

The panel 235 can define a volume of space to house a portion of a curtain airbag, for example. In various embodiments, one or more curtain airbags may be disposed proximate, adjacent, or within the interior surface 210 (e.g., within a volume of space surrounded by the interior surface 210) of the interior trim system 230. For example, the interior trim system 230 may include a space, pocket, opening, or the like to house a portion of a curtain airbag disposed between the panel 235 and a portion of an interior surface 210 of the front-end pillar 130 in an attached position, as discussed in greater detail below.

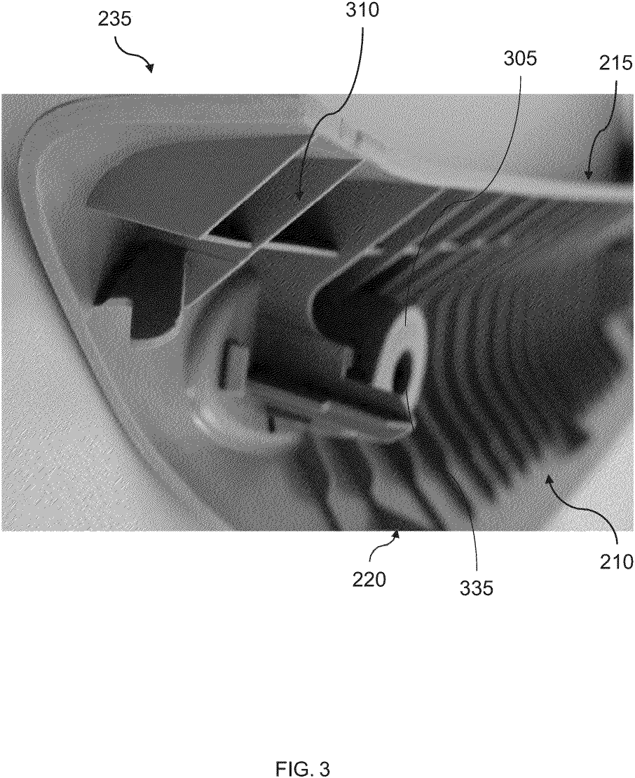

FIG. 3 depicts a detailed view of the interior surface 210 of the panel 235, according to an exemplary embodiment. As shown in FIG. 3, the panel 235 may include a boss 305 extending from the interior surface 210 of the panel 235. For example, the boss 305 may be a projection, extension, or other similar protrusion extending from a portion of the panel 235. In various embodiments, the boss 305 may extend from the interior surface 210 of the panel 235. For example, the boss 305 may project from one or more portions of the interior surface 210 and into a portion of the volume of space disposed between the interior surface 210 and the front-end pillar 130, as shown in FIG. 3. The boss 305 may couple to, or integrally form with, the panel 235 through various means including, but not limited to, welding, adhesives, fasteners, additive manufacturing, subtractive manufacturing, or the like. In various embodiments, the boss 305 may be made from the same material as the panel 235. In various embodiments, the boss 305 may be made from a different material than the panel 235.

In some embodiments, the panel 235 may include a unitary structure (e.g., formed via additive manufacturing). In some embodiments, the panel 235 may include one or more structures coupled together to form the panel 235 (e.g., via fasteners, welding, adhesives, etc.). For example, in various embodiments, one or more portions of the panel 235, such as the boss 305 of the panel 235, may be manufactured simultaneously with the rest of the panel 235 (e.g., via injection molding, 3D printing, etc.). In various embodiments, one or more portions of the panel 235, such as the boss 305 of the panel 235 may be manufactured or formed with the panel 235 separately via welding, fasteners, adhesives, or the like.

In various embodiments, the panel 235 may be formed of various non-metallic materials. For example, the panel 235 may be formed of various plastics, resins, carbon fibers, rubbers, or the like. In various embodiments, the panel 235 may be formed of various metallic materials. For example, the panel 235 may be formed of various metals including, but not limited to, steel, aluminum, copper, brass, cast iron, or bronze. In various embodiments, the panel 235 may be formed of a combination of metallic and non-metallic materials. For example, one portion of the panel 235 may be made of a metallic material, while a second portion of the panel 235 may be made of a non-metallic material.

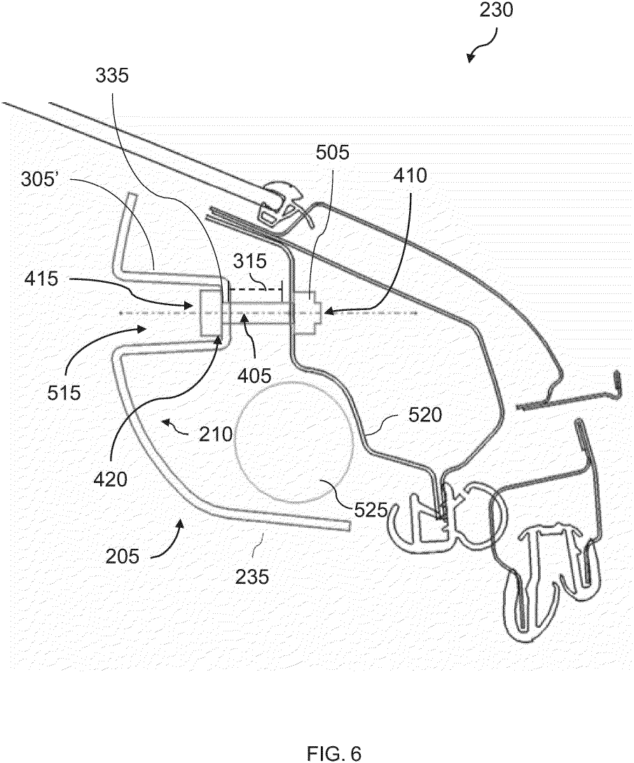

In various embodiments, the boss 305 may include an aperture 335. For example, the aperture 335 may include any hole, opening, slot, or the like within the boss 305 (e.g., disposed on a surface of the boss 305) to receive a portion of a shoulder bolt 400, as described below. In various embodiment, the aperture 335 can at least partially extend between the user-facing surface 205 and the interior surface 210 within the boss 305. For example, as shown in FIGS. 3 and 6, the boss 305 may extend from a portion of the interior surface 210 and the aperture 335 may be positioned within a portion of the boss 305 such that the aperture 335 extends along a portion of the length of the boss 305 from the interior surface 210. For example, in various embodiments, the aperture 335 is a through-hole within the boss 305 disposed between the user-facing surface 205 and the interior surface 210 in the boss 305. In some embodiments, a cover is provided to close the opening in the user-facing surface 205 so that the user does not see the shoulder bolt 400 in normal conditions.

In various embodiments, the boss 305 may include one or more tapered regions, such as a countersunk (e.g., counter bore, sunken, etc.) region disposed proximate the user-facing surface 205. In some embodiments, the aperture 335 may only partially extend between the user-facing surface 205 and the interior surface 210. For example, the aperture 335 may only extend along a portion of the length of the boss 305. In various embodiments, the interior trim system 230 may include one or more components configured to cover the aperture 335 from being exposed to a user within the cabin 115. For example, the interior trim system 230 may include a cover, a cap, a portion of the panel 235, or the like to cover a portion of the aperture 335 near the user-facing surface 205. In various embodiments, the interior trim system 230 may not include a cover such that the aperture 335 is exposed (e.g., visible) to a user near the user-facing surface 205.

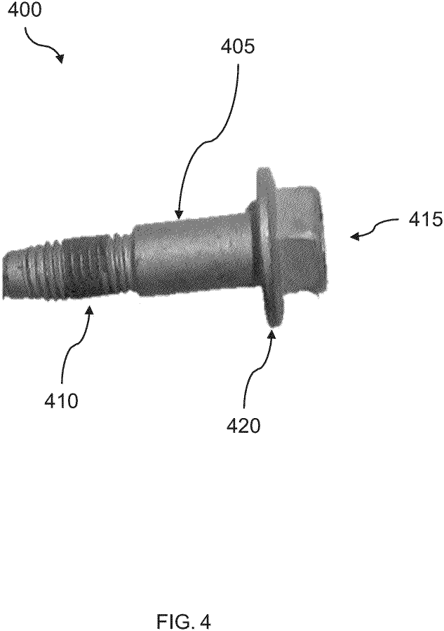

In various embodiments, the aperture 335 may be configured to receive a portion of a shoulder bolt 400. As depicted in FIG. 4, the shoulder bolt 400 may include a head portion 415, a flange portion 420, a smooth portion 405, or a threaded portion 410. For example, in various embodiments, the aperture 335 can receive a portion of the shoulder bolt 400 such that the shoulder bolt 400 facilitates coupling the panel 235 to a portion of the front-end pillar 130 of the vehicle 100. In some embodiments, the aperture 335 may receive a portion of the shoulder bolt 400 such that the head portion 415 of the shoulder bolt 400 is disposed near the user-facing surface 205 and the threaded portion 410 is disposed near the interior surface 210. For example, the head portion 415 of the shoulder bolt 400 may abut a portion of a countersunk hole, as described in greater detail below.

In various embodiments, the interior trim system 230 may be configured to operate in an attached position during normal operating conditions (e.g., without impact, collision, or the like). In the attached position, an un-deployed curtain airbag may be disposed within the panel 235 (e.g., within the volume of space described above in reference to FIG. 2). In the attached position, the panel 235 may be tightly coupled with an interior portion of the front-end pillar 130 such that no gaps, spaces, or the like form between the panel 235 and the interior portion of the front-end pillar 130 (e.g., the airbag is not exposed, the interior surface 210 is not exposed, etc.). In the attached position, the shoulder bolt 400 may facilitate coupling the panel 235 with the interior portion of the front-end pillar 130. For example, the threaded portion 410 of the shoulder bolt 400 may threadably couple to another portion of the trim system 230 (e.g., to a nut 505 disposed proximate the interior portion of the vehicle abutting the boss 305) to facilitate keeping the panel 235 tightly coupled to the interior portion of the front-end pillar 130, as described in greater detail below.

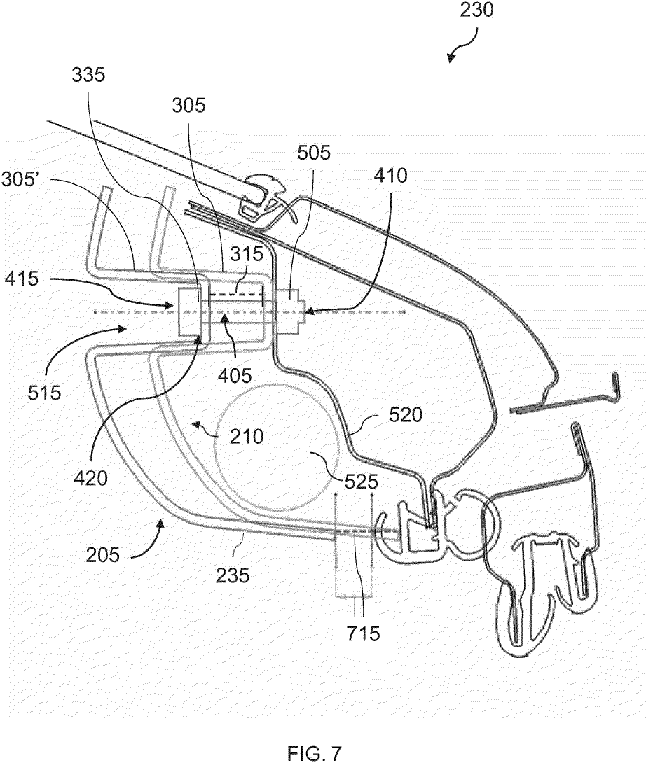

FIG. 5 illustrates a cross-sectional view of the trim system 230 in the attached position, according to an exemplary embodiment. Specifically, FIG. 5 shows a cross-sectional view of the panel 235 along a plane extending between a center portion of the boss 305. As shown in FIG. 5, the flange portion 420 of the shoulder bolt 400 may be spaced at a threshold distance 315 from another portion of the trim system 230, such as the surface of the boss 305 in which the aperture 335 is formed. As described in greater detail below, the gap distance 715 may be the distance the panel 235 is allowed to move relative to the shoulder bolt 400 to provide a gap between the panel 235 and the interior portion of the front-end pillar 130 (e.g., distance 715 shown in FIG. 7) for the airbag 525 to expel out from between the panel 235 and the vehicle portion 520. As shown in FIG. 5, a portion of the threaded portion 410 of the shoulder bolt 400 may threadably engage with a portion of a nut 505 disposed adjacent another portion of the vehicle 100 abutting the boss 305 (e.g., vehicle portion 520) to facilitate coupling the panel 235 with the vehicle 100. The nut 505 may include one or more threaded regions to engage with the threaded portion 410 of the shoulder bolt 400 and may facilitate coupling the shoulder bolt 400 with the panel 235.

As shown in FIG. 5, the boss 305 may include a countersunk region 515. For example, the boss 305 can include the countersunk region 515 such that the boss 305 is countersunk from the user-facing surface 205 such that the aperture 335 is disposed away from (e.g., spaced away from, not parallel with, etc.) the user-facing surface 205. In some examples, the countersunk region 515 is deeper (e.g., from the user-facing surface 205 to the interior surface 210) than the length of the shoulder bolt 400 such that, even in a deployed position as described below, the head portion 415 of the shoulder bolt 400 does not project past at least one portion of the user-facing surface 205, as shown in FIG. 6.

In various embodiments, the interior trim system 230 may be configured to operate in a deployed position during an impact. By way of example, the vehicle 100 may undergo a collision with another vehicle or object. During such collision, the un-deployed curtain airbag 525 may be configured to deploy. For example, the airbag 525, or other portions of the vehicle 100, may include various sensors to detect collision and subsequently cause chemicals within the airbag 525 to generate inflatable gases within a shortened time period (e.g., 0.001 seconds, 0.01 seconds, 0.1 seconds, 1 second, etc.). Such inflation may cause the airbag 525 to expand and be deployed (e.g., ejected, pushed, expelled) out of the panel 235 and towards another portion of the cabin 115. During such deployment, the panel 235 may be configured to shift, slide, or otherwise move, a predetermined distance and direction relative to the shoulder bolt 400 to properly provide a space for the airbag 525 to expel from within the interior trim system 230. For example, the panel 235 may be configured to move an outward direction (e.g., normal to the interior surface 210, towards the cabin 115, about parallel with the length of the shoulder bolt 400, etc.).

In various embodiments, a portion of the panel 235 may be configured to move relative to (e.g. about, along, etc.) the smooth portion 405 of the shoulder bolt 400 a predetermined threshold distance when transitioning from the attached position to the deployed position. In various embodiments, the panel 235 may be configured to move about 5 millimeters relative to the shoulder bolt 400 (e.g., the gap distance 715 shown throughout the figures). In various embodiments, the panel 235 may be configured to move about 10 millimeters relative to the shoulder bolt 400. In various embodiments, the panel 235 may be configured to move more than 10 millimeters relative to the shoulder bolt 400. The movement of the panel 235 relative to the shoulder bolt 400 may facilitate providing a gap between the panel 235 and the interior portion of the front-end pillar 130. By way of example, the panel 235 may be configured to move about 10 millimeters away from the interior portion of the front-end pillar 130 (e.g., towards a user of the cabin 115) such that a gap of about the same distance (e.g., about 10 millimeters in this example) may form between the panel 235 and the interior portion of the font-end pillar. When the gap is formed, the airbag 525 may be configured to expel out of the gap and towards a user to facilitate preventing injury of the user.

FIG. 6 illustrates a cross-sectional view of the trim system 230 in the deployed position, according to the exemplary embodiment shown in FIG. 5. Specifically, FIG. 6 shows a cross-sectional view of the panel 235 along a plane extending along a center portion of the boss 305. FIG. 7 illustrates an overlay of the FIGS. 5 and 6 to illustrate the movement from the attached position to the deployed position. As shown between FIG. 5 and FIG. 6 and in FIG. 7, the panel 235 may move the threshold distance (e.g., the gap threshold distance 315 between the boss in the attached position (305 in FIG. 5) and the boss in the deployed position (305′ in FIG. 6)) relative to the shoulder bolt 400 to create a gap distance 715 between for the airbag 525 to expel out from between the panel 235 and the vehicle portion 520. For example, the panel 235 may move relative to the shoulder bolt 400 such that the flange portion 420 of the shoulder bolt 400 engages with another portion of the panel 235, such as an opening of the aperture 335 of the boss 305 (e.g., such that there is no longer any distance or the distance has decreased between the flange portion 420 and the boss 305, as shown in FIG. 6 and FIG. 7). In some examples, the threshold distance 315 between the flange portion 420 of the shoulder bolt 400 and the aperture 335 of the boss 305 may be the distance at which the panel 235 moves relative to the shoulder bolt 400 to provide a gap 715 between the panel 235 and the interior portion of the front-end pillar 130 for the airbag 525 to expel out from a portion of the panel 235.

In various embodiments, deployment of the airbag 525 may cause the panel 235 to move relative to the shoulder bolt 400. For example, the force or pressure against the interior surface 210 of the panel 235 due to inflation of the airbag 525 may cause the panel 235 to move relative to the shoulder bolt 400. In some embodiments, the panel 235 may move relative to the shoulder bolt 400 until the flange portion 420 of the shoulder bolt 400 engages with another portion of the panel 235, as described above.

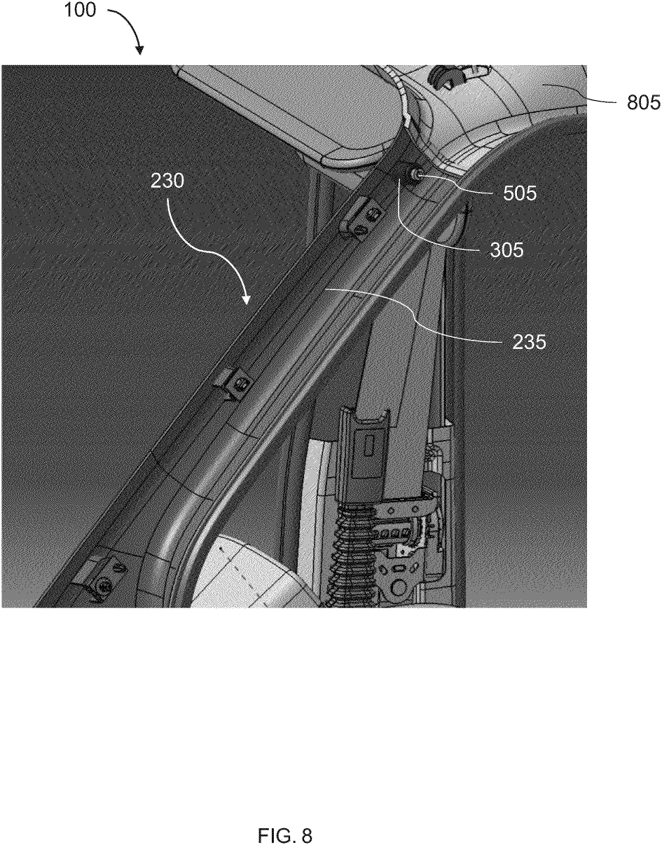

FIG. 8 depicts a perspective view of a portion of the interior trim system 230 within the vehicle 100, according to an exemplary embodiment. As shown in FIG. 8, the trim system 230 can couple with one or more portions of the vehicle 100, such as a ceiling section 805. For example, the interior trim system 230 can couple to one or more portions of the vehicle 100 through various means including, but not limited to, fasteners, welding, adhesives, or other similar methods.

In various embodiments, the panel 235 may include a plurality of ribs 310, as shown in FIG. 3. Each of the plurality of ribs 310 may extend at least partially between the top end 215 of the panel 235 and the boss 305 of the panel 235. In various embodiments, the plurality of ribs 310 may be angled in a direction such that when the airbag 525 is deployed (e.g., in the deployed position described above), a portion of the airbag 525 engages the ribs 310 and the airbag 525 is inhibited from expelling in an upward direction (e.g., towards the top end 215 of the panel 235). For example, the plurality of ribs 310 may facilitate directing the airbag 525 out of the gap through either the bottom end 220 portion of the gap or at least partially through the bottom end 220 portion and the first side 240 portion or the second side 245 portion of the gap. The panel 235 may include any number of ribs 310. For example, the panel 235 may include two ribs 310. The panel 235 may include three ribs 310, as another example. The panel 235 may include four or more ribs 310, as yet another example.

In various embodiments, the ribs 310 may be integrally formed with the panel 235. For example, the ribs 310 may be manufacturing simultaneously with the panel 235. In various other embodiments, the ribs 310 may couple to one or more portions of the panel 235. For example, the ribs 310 may couple to the panel 235 through fasteners, welding, adhesives, or another similar technique. In some embodiments, the ribs 310 may be the same material as the panel 235. In some embodiments, the material of the ribs 310 may differ from the material of the panel 235.

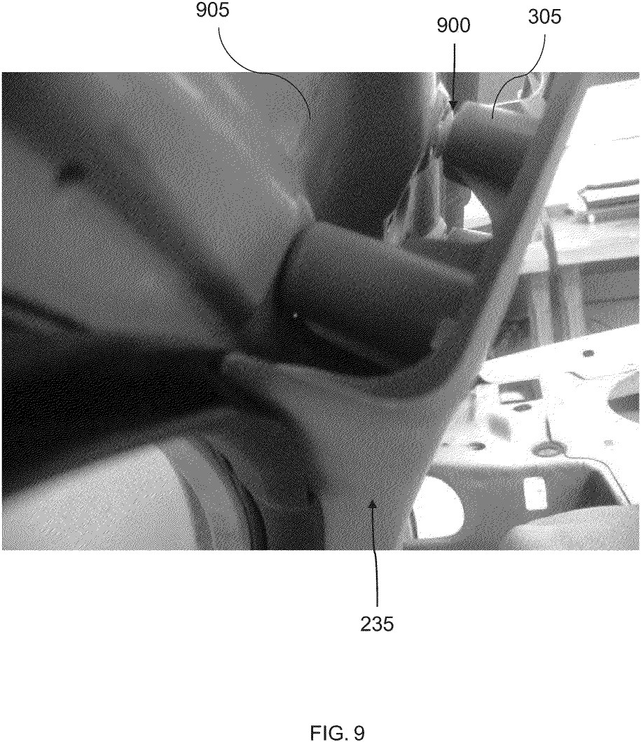

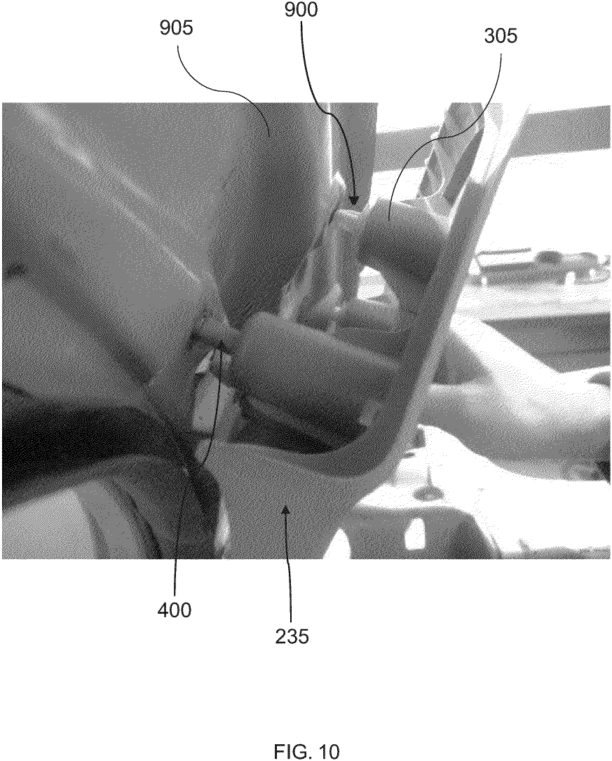

FIG. 9 illustrates a portion of the panel 235 in an attached position, according to an exemplary embodiment. FIG. 10 illustrates the panel 235 in the deployed position, according to the exemplary embodiment of FIG. 9. As shown between FIG. 9 and FIG. 10, the panel 235 may move away from the interior portion of the vehicle 100, shown as interior trim portion 905, between the attached position shown in FIG. 9 and the deployed position shown in FIG. 10. In some embodiments, the panel 235 may move away from the interior trim portion 905 relative to the shoulder bolt 400 within the aperture 335 of the boss 305, as shown between the attached position in FIG. 9 and the deployed position in FIG. 10.

As shown in at least FIGS. 9 and 10, in some embodiments, the panel 235 may include one or more attachments, such as a push retainer 900 to facilitate coupling the panel 235 with the interior trim portion 905. For example, the push retainer 900 may include a rivet, retainer, clip, barbed connector, Christmas tree fastener, or the like to facilitate coupling the panel 235 with a portion of the vehicle 100 in the attached position. In some embodiments, the panel 235 may include one or more push retainers 900 positioned separate from or at a distance from the shoulder bolt 400 such that the push retainer 900 facilitates coupling the panel 235 with the interior trim portion 905 at various portions of the panel 235, as shown in FIGS. 9 and 10.

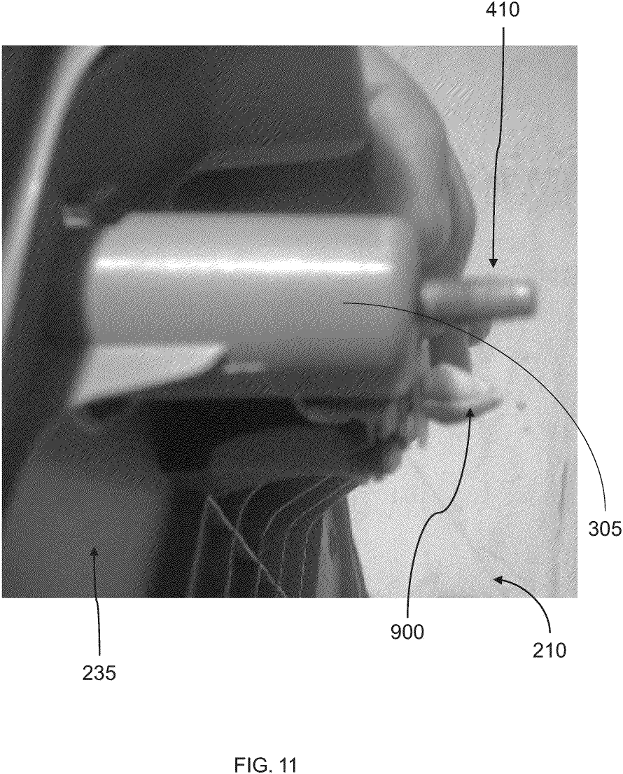

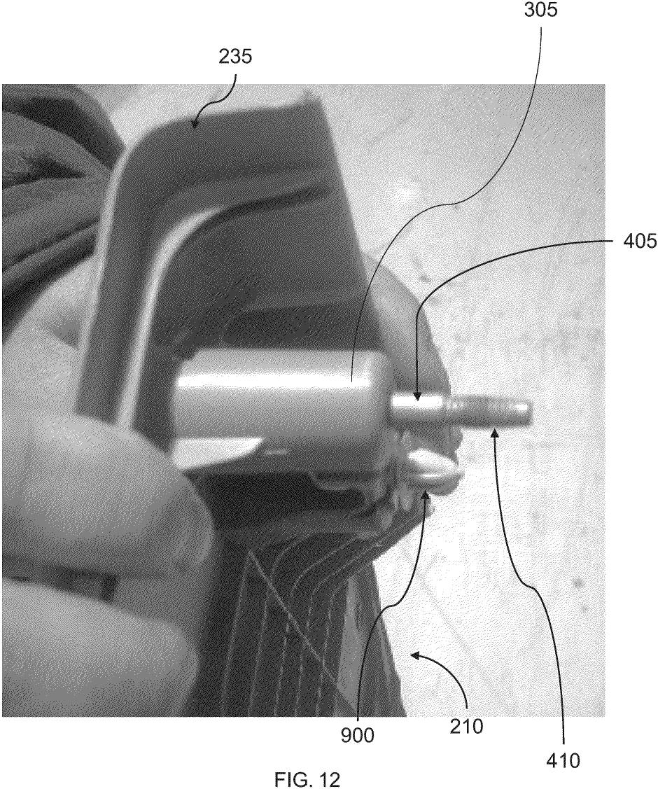

FIG. 11 illustrates a portion of the panel 235 in an attached position, according to an exemplary embodiment. FIG. 12 illustrates the portion of the panel 235 in the deployed position, according to the exemplary embodiment of FIG. 11. Specifically, FIGS. 11 and 12 show a portion of the panel 235 from the interior surface 210 of the panel 235. The interior trim portion 905 is not shown in FIGS. 11 and 12 so as to illustrate movement of the panel 235 relative to the shoulder bolt 400. As shown between FIG. 11 and FIG. 12, the panel 235 may move away from the interior portion of the vehicle 100, such that more of the shoulder bolt 400 is exposed outside of the boss 305. For example, as shown between FIGS. 11 and 12, as the trim system 230 moves between the attached position shown in FIG. 11 and the deployed position shown in FIG. 12, the threaded portion 410 of the shoulder bolt 400 may become more exposed outside of the aperture 335 of the boss 305. In some embodiments, the panel 235 may move such that the smooth portion 405 of the shoulder bolt 400 is exposed outside of the boss 305, as shown in FIG. 12.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the vehicle 100 and components thereof (e.g., the panel 235, the wheels 120, etc.) as shown in the various exemplary embodiments is illustrative only. Additionally, any element disclosed in one embodiment may be incorporated or utilized with any other embodiment disclosed herein.

What is claimed is:

1. An interior trim system of a front pillar of a vehicle, comprising:
a panel, comprising:
a user-facing surface of the panel and an interior surface of the panel, the interior surface located opposite the user-facing surface, the interior surface defining a volume of space to house a portion of a curtain air bag in an attached position;
a boss extending from the interior surface of the panel;
an aperture extending from the user-facing surface through the boss;
a shoulder bolt having a head portion, a flange, a smooth portion, and a threaded portion; and
wherein in a deployed position, the panel is configured to move relative to the shoulder bolt by a predetermined threshold distance such that the curtain air bag can deploy through an opening created by movement of the panel.

2. The interior trim system of claim 1, wherein the boss includes a countersunk region and wherein the flange of the shoulder bolt engages with a portion of the countersunk region in the deployed position.

3. The interior trim system of claim 1, wherein the panel includes a top end, a bottom end, and a plurality of ribs extending along the interior surface of the panel between the boss and the top end.

4. The interior trim system of claim 3, wherein the plurality of ribs are configured to prevent the curtain air bag from deploying towards the top end of the panel in the deployed position.

5. The interior trim system of claim 1, further comprising a push retainer coupled to a portion of the shoulder bolt within the aperture of the boss.

6. The interior trim system of claim 5, wherein the push retainer is configured to prevent the panel from moving relative to the shoulder bolt in the attached position.

7. The interior trim system of claim 1, wherein the predetermined threshold distance is at least 10 millimeters.

8. The interior trim system of claim 1, wherein the panel is configured to move relative to the shoulder bolt along the smooth portion of the shoulder bolt.

9. The interior trim system of claim 1, further comprising a nut disposed adjacent the boss and configured to receive a portion of the threaded portion of the shoulder bolt.

10. The interior trim system of claim 1, wherein the boss includes a countersunk region and wherein a flange of a push retainer coupled to the shoulder bolt engages with a portion of the countersunk region in the deployed position.

11. A vehicle, comprising:
an exterior and an interior;
a front pillar disposed adjacent a portion of the interior of the vehicle;
an interior trim system of the front pillar, comprising:
a panel, comprising:
a user-facing surface of the panel and an interior surface of the panel, the interior surface located opposite the user-facing surface, the interior surface defining a volume of space to house a portion of a curtain air bag in an attached position;
a boss extending from the interior surface of the panel;
an aperture extending from the user-facing surface through the boss;
a shoulder bolt having a head portion, a flange, a smooth portion, and a threaded portion; and
wherein in a deployed position, the panel is configured to move relative to the shoulder bolt by a predetermined threshold distance such that the curtain air bag can deploy through an opening created by movement of the panel.

12. The interior trim system of claim 1, wherein the boss includes a countersunk hole and wherein the flange of the shoulder bolt engages with a portion of the countersunk hole in the deployed position.

13. The interior trim system of claim 1, wherein the panel includes a top end, a bottom end, and a plurality of ribs extending along the interior surface of the panel between the boss and the top end.

14. The interior trim system of claim 13, wherein the plurality of ribs are configured to prevent the curtain air bag from deploying towards the top end of the panel in the deployed position.

15. The interior trim system of claim 11, further comprising a push retainer coupled to a portion of the shoulder bolt within the aperture of the boss.

16. The interior trim system of claim 15, wherein the push retainer is configured to prevent the panel from moving relative to the shoulder bolt in the attached position.

17. The interior trim system of claim 11, wherein the predetermined threshold distance is at least 10 millimeters.

18. The interior trim system of claim 11, wherein the panel is configured to move relative to the shoulder bolt along the smooth portion of the shoulder bolt.

19. The interior trim system of claim 1, further comprising a nut disposed adjacent the boss and configured to receive a portion of the threaded portion of the shoulder bolt.

20. The interior trim system of claim 11, wherein the boss includes a countersunk region and wherein a flange of a push retainer coupled to the shoulder bolt engages with a portion of the countersunk region in the deployed position.
